(19) United States
(12) Patent Application Publication
(10) Pub. No.: US 2010/0183054 A1
(43) Pub. Date: Jul. 22, 2010

(54) METHOD FOR THE ROBUST SYNCHRONIZATION OF A MULTI-CARRIER RECEIVER USING FILTER BANKS AND CORRESPONDING RECEIVER AND TRANSCEIVER

(76) Inventors: Donnacha Daly, Luzern (CH); Stephan Horvath, Ipsach (CH); Anthony Jamin, South Brent (GB)

Correspondence Address: BLANK ROME LLP, WATERGATE, 600 NEW HAMPSHIRE AVENUE, N.W., WASHINGTON, DC, 20037, US

(21) Appl. No.: 12/531,982

(22) PCT Filed: Mar. 19, 2008
(86) PCT No.: PCT/EP07/52561

§ 371 Date: Mar. 3, 2010

(51) Int. Cl. H04B 1/38; H04L 27/00; H04L 7/00

(52) U.S. Cl. 375/219; 375/344; 375/354

(57) ABSTRACT

Synchronization method for a multi-carrier transceiver using a filter bank, for example a cosine modulated filter bank, a wavelet packet filter bank or a complex modulated filter bank, the transceiver comprising a transmitter (100) and a receiver (300) able to communicate with each other over a communication channel (200), the method comprising the following steps: sending a periodic and coded training sequence over the communication channel (200) with the transmitter (100), determining in the receiver (300) time alignment information from the received training sequence, performing a coarse synchronization of the receiver (300) to said transmitter (100) using said time alignment information, sending modulated data (1) in data mode over the communication channel (200) with the transmitter (100), pilot signals being multiplexed into said data (1), tracking sampling frequency offset and phase jitter within the receiver (300) using the pilot signals, performing the continuous synchronization of the transceiver with the help of the tracking information determined in the step of tracking. The invention also relates to a multi-carrier transceiver, consisting of a transmitter (100) and a receiver (300), able to perform this synchronization method.

### FIELD OF THE INVENTION

The invention relates to a synchronization method to be used in multi-carrier transceivers employing filter banks, for example cosine modulated filter banks, wavelet packet filter banks or complex modulated filter banks, at very low signal-to-noise ratio and large frequency offset, and to a receiver adapted to perform this method.

### DESCRIPTION OF RELATED ART

Prior art synchronization methods have been developed for single-tone Carrier-less Amplitude Modulation (CAP) or for digital multi-tone (DMT) and orthogonal frequency division multiplexing (OFDM) transceivers.

The sensitivity to carrier frequency offset and phase noise of DMT and OFDM transceivers is a well-known disadvantage of these modulation techniques over CAP modulation.

Multi-carrier transceivers using digital filter banks, for example cosine modulated filter banks, wavelet packet filter banks or complex modulated filter banks, have a better spectral properties than DMT and OFDM transceivers since they provide a better stop-band attenuation, but their synchronization is more challenging.

Joint frequency offset and timing mismatch detection and correction techniques such as that described in EP 0 827 655 are not appropriate for use in multi-carrier transceivers employing filter banks, especially when the signal-to-noise ratio at the receiver is very low and/or the carrier frequency offset is large.

U.S. Pat. No. 5,228,062 discloses a method and system for coarse synchronization of multi-tone receivers based on OFDM modulation which uses single-tone transmission to achieve coarse synchronization during a training period. Thereby, the carrier frequency offset and the timing mismatch is also jointly estimated and corrected prior to data transmission in multi-tone communication mode. The coarse synchronization is achieved by means of an energy detector, which locks on a null symbol transition. Two single pilot tones are then used for simultaneous frequency and timing error estimation and correction. It is to be noticed that this only allows acquisition over a narrow offset frequency range.

Another limitation of the devices and methods of the prior art is that their performances are degraded when some frequency bands inside the operation band cannot be employed to endure coexistence.

### BRIEF SUMMARY OF THE INVENTION

An aim of the present invention is thus to provide a method for synchronizing multi-carrier transceivers using filter banks, for example cosine modulated filter banks, wavelet packet filter banks or complex modulated filter banks, even at very low signal-to-noise ratio and large carrier frequency offsets, (as encountered for example in broadband communications over power lines).

Another aim of the present invention is to propose a multi-carrier transceiver using filter banks, for example cosine modulated filter banks, wavelet packet filter banks or complex modulated filter banks, which can be synchronized even at very low signal-to-noise ratio and large carrier frequency offsets, (as encountered for example in broadband communications over power lines).

According to the invention, these aims are achieved by means of a synchronization method comprising the features of the corresponding independent claim and, in particular, by a synchronization method for a multi-carrier transceiver using a filter bank, for example a cosine modulated filter bank, a wavelet packet filter bank or a complex modulated filter bank, the transceiver comprising a transmitter and a receiver able to communicate with each other over a communication channel, the method comprising the following steps:

in a training mode of operation: sending a periodic and coded training sequence over the communication channel from the transmitter,

determining in the receiver time alignment information from the received training sequence,

performing a coarse synchronization of the receiver to said transmitter using said time alignment information,

in a data mode of operation: sending multi-carrier modulated data over the communication channel from the transmitter, pilot signals being multiplexed into said data,

tracking sampling frequency offset and phase jitter within the receiver using the received pilot signals,

performing the continuous synchronization of the transceiver with the help of the tracking information determined using the received pilot signals.

According to the invention, these aims are achieved by means of a receiver for the reception of multi-carrier signals, comprising the features of the corresponding independent claim and, in particular comprising:

a signal processing unit using a filter bank for demodulating a multi-carrier signal, for example a cosine modulated filter bank, a wavelet packet modulated filter bank or a complex modulated filter bank,

a pre-processing unit for the pre-processing of a received signal,

a coarse synchronization unit for determining tuning parameters of the pre-processing unit in order to perform a coarse synchronization of the receiver to a transmitter when the transmitter and the receiver communicate with each other over a transmission channel,

switching means for connecting the output of the pre-processing unit either to the input of the coarse synchronization unit or to the input of the signal processing unit,

wherein the coarse synchronization unit comprises a time alignment module for determining time alignment information from a received training sequence.

According to the invention, these aims are achieved by means of a transceiver comprising such a receiver and a transmitter.

According to the invention, a periodic and coded training sequence in which the forbidden frequency bands are notched out is first sent to allow the receiver of the called party to synchronize to the transmitter even at low signal-to noise ratio and large carrier frequency offset. Once this coarse synchronization is performed, the transmitter starts sending multi-carrier modulated data with multiplexed pilot tones in data mode. The multiplexed pilot tones are used in the receiver for continuously tracking phase jitter and timing deviation of the received signal in order to allow the correct synchronization of the transceiver by applying the necessary corrective measures within the receiver.

According to a preferred embodiment of the invention, coarse synchronization is performed while the transceiver is in a training mode in which the transmitter sends a periodic and coded training sequence. In a first step, time alignment is determined using matched filters optimized for the transmitted training sequence. In a second step, the thus obtained time alignment information is used to detect and correct the carrier frequency offset, using the training sequence known to the receiver. Once the carrier frequency offset is corrected, the coefficients of a time-domain equalizer within the receiver are calculated for example by minimizing a frequency weighted mean-square error (MSE) between the equalized, carrier frequency offset corrected and time aligned received signal and a known and preferably locally generated training sequence.

According to the invention, once coarse synchronization is achieved, the receiver switches to data mode. Preferably, the receiver comprises means to track symbol alignment deviations and carrier frequency jitter, which are due for example to frequency jitter of the local oscillator. In a preferred embodiment, these means make use of pilot tones multiplexed into the data sent by the transmitter. The applied multi-carrier synchronization technique preferably implies time-domain sampling frequency error detection and correction, while phase and frequency deviations are preferably corrected by a phase rotator.

Typically, the transceiver of the invention uses transmission channels of different bandwidths (for example channels of 0.5 MHz, 1 MHz, 2 MHz, 4 MHz and/or 8 MHz). In an embodiment, these bandwidth limited channels are comprised for example in the frequency band of 1.6 MHz to 100 MHz.

In a preferred embodiment, the switchover from training mode to data mode is initiated by the detection of a received periodic and coded training sequence.

### BRIEF DESCRIPTION OF THE DRAWINGS

A better understanding of the present invention can be obtained when the following detailed description of embodiments of the invention is considered in conjunction with the following figures, in which:

FIG. 1 is a block diagram of a multi-carrier transceiver according to a preferred embodiment of the invention.

FIG. 2 shows an example of partitioning of the communication channel into sub-channels of different bandwidths.

FIG. 3a is a partial block diagram of a receiver according to a preferred embodiment of the invention in training mode.

FIG. 3b is a partial block diagram of a receiver according to a preferred embodiment of the invention in data mode.

FIG. 4a shows an example of a simple coded training sequence in which the forbidden frequency bands are notched out.

FIG. 4b shows the result of the matched filtering of the signal of FIG. 4a.

FIG. 5a shows the demodulated in-phase part of the noisy signal received when the training sequence of FIG. 4a is transmitted over a bandpass communication channel.

FIG. 5b shows the demodulated quadrature part of the noisy signal received when the training sequence of FIG. 4a is transmitted over a bandpass communication channel.

FIG. 6a shows the result of the matched filtering of the demodulated in-phase part (FIG. 5a).

FIG. 6b shows the result of the matched filtering of the demodulated quadrature part (FIG. 5b).

FIG. 7 illustrates the data-aided iterative estimation of the carrier frequency offset carried out during training mode, in accordance with a preferred embodiment of the present invention.

FIG. 8a shows the tracking performance of the phase rotator according to an embodiment of the present invention during data mode.

FIG. 8b shows the phase tracking error of the phase rotator according to a preferred embodiment of the present invention at a signal-to-noise ratio of 0 dB.

FIG. 8c shows the phase tracking error of the phase rotator according to a preferred embodiment of the present invention at a signal-to-noise ratio of 5 dB.

FIG. 8d shows the phase tracking error of the phase rotator according to a preferred embodiment of the present invention at a signal-to-noise ratio of 10 dB.

FIG. 9a shows the synchronization performance of an interpolator/re-sampler according to a preferred embodiment of the present invention to correct the sampling frequency and phase error during the data mode.

FIG. 9b shows the error signal corresponding to the synchronization performance of FIG. 9a.

### DETAILED DESCRIPTION OF POSSIBLE EMBODIMENTS OF THE INVENTION

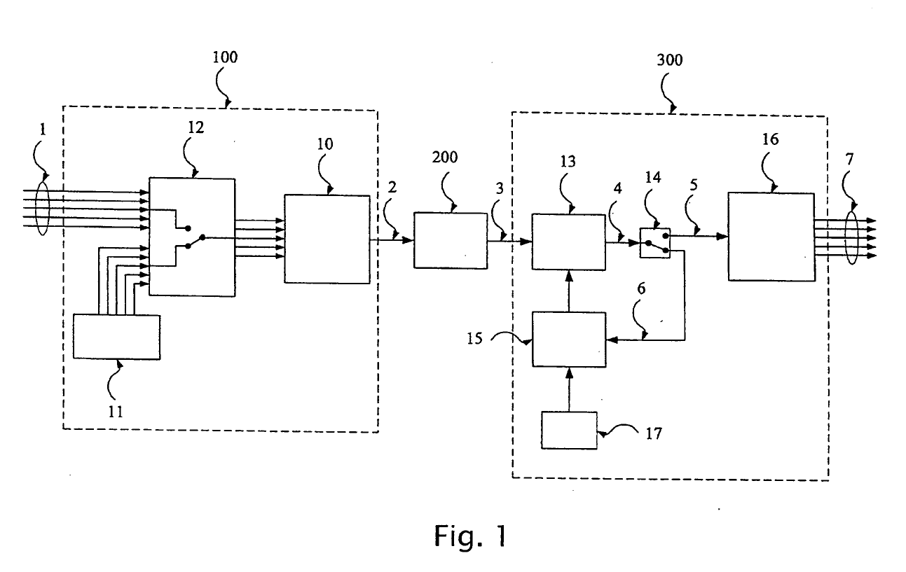

FIG. 1 is a simplified block diagram of a multi-carrier transceiver using filter banks according to a preferred embodiment of the invention. The transceiver includes a transmitter 100 using for example a discrete cosine modulated filter bank, a wavelet packet filter bank or a complex modulated filter bank, and a corresponding receiver 300.

The transmitter 100 and the receiver 300 can communicate with each other over a communication channel 200. In the description below, the communication channel 200 is assumed to be either baseband or bandpass and noisy, and to have a highly frequency-selective attenuation and phase response. Such a communication channel can be encountered for example in broadband communication over power lines. Any other wired, wireless or mixed communication channel can however be used with the transceiver of the invention.

The transmitter 100 comprises a modulator 10 using a filter bank, for example a discrete cosine modulated filter bank, a wavelet packet filter bank or a complex modulated filter bank, for modulating input data 1 to be transmitted to the receiver 300 over the communication channel 200. According to the invention, the transmitter 100 comprises a training sequence generator 11 for generating a periodic and coded training sequence which will be used in a training mode for coarsely synchronizing the receiver 300 to the transmitter 100, as will be explained further below. The transmitter 100 further comprises switching means 12, for example a mechanical, electronic or electromechanical switch, for connecting the filter bank input either to the output of the training sequence generator 11 in training mode, or to the data (1) to be transmitted in data mode.

The receiver 300 comprises a pre-processing unit 13 for down-converting in the bandpass case and equalizing the received signal 3, and a coarse synchronization unit 15 for determining parameters for tuning the pre-processing unit 13 and thus performing the coarse synchronization of the transceiver, as will be explained more in details below. The receiver 300 further comprises a signal processing unit 16 for demodulating the received signal and thus generating the output data 7 corresponding to the sent input data 1. The demodulation is performed using a filter bank, for example a discrete cosine modulated filter bank, a wavelet packet filter bank or a complex modulated filter bank, preferably the inverse of the filter bank used in the modulator 10 of the transmitter 100. Preferably, the signal processing unit 16 also performs fine synchronization and tracking, as will be explained further below. The receiver 300 further comprises a reference training sequence generator 17 for generating a periodic and coded training sequence, and switching means 14, for example a mechanical, electronic or electromechanical switch, for directing the output 4 of the pre-processing unit 13 either to the coarse synchronization unit 15 in training mode, or to the signal processing unit 16 in data transmission mode.

According to the invention, the multi-carrier transceiver of FIG. 1 is thus operable in two distinct modes: a training mode and a data mode. The transceiver can be switched from one mode to the other by means of the switching means 12 and 14. The training mode is used to perform coarse synchronization at the beginning of a communication session between the transmitter 100 and the receiver 300, while fine synchronization and tracking is performed during data mode, together with multi-carrier data modulation, transmission and demodulation.

Training Mode

At the beginning of a communication session, the transmitter 100 is switched to training mode. In this mode, the switching means 12 of the transmitter are switched such that the signal 2 sent by the transmitter 100 corresponds to the periodic and coded training sequence generated by the filter bank 10 using the data coming from the training sequence generator 11, while the switching means 14 in the receiver 300 are switched such that the output of the pre-processing unit 16 is directed to the coarse synchronization unit 15.

The signal 2 sent by the transmitter 100 in training mode thus corresponds to a periodic and coded training sequence generated by the filter bank 10 using the data coming from the training sequence generator 11. According to the invention, the sent signal 2 in training mode is a periodic and coded training sequence in which the forbidden frequency bands are notched. As will be explained more in details below, the receiver 300 comprises means 15, 13 to detect the time alignment of the received periodic and coded training sequence in spite of low signal-to-noise ratio of the received signal 3, using time-domain matched filtering techniques.

The resulting time alignment information is then used together with a known training sequence 8 to estimate and carry out the necessary carrier frequency offset adjustments within the receiver 300. The known periodic and coded training sequence 8 is preferably generated locally by using the training sequence generator 17, The coefficients of a time-domain equalizer within the pre-processing unit 13 are then adjusted in order to minimize the adverse effects of the communication channel 200 and thus achieve coarse synchronization of the transceiver.

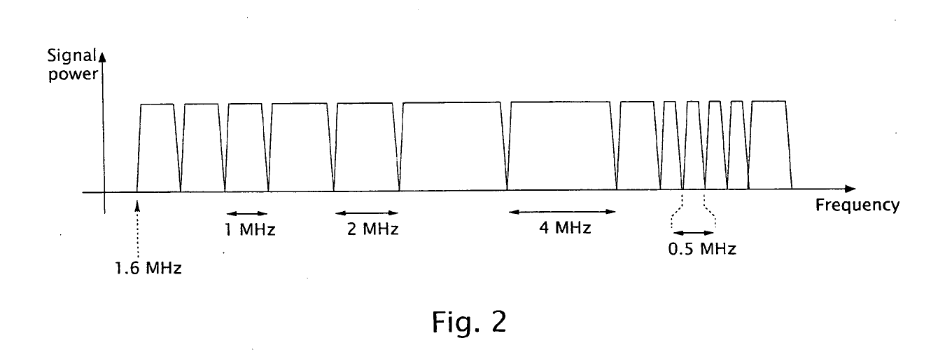

In a preferred embodiment, the bandwidth available for communication between the transmitter 100 and the receiver 300 is divided in sub-channels of different bandwidths, as schematically illustrated for example in FIG. 2, wherein the horizontal axis represents the frequency and the vertical axis is the signal power spectral density. In this particular example, the bandwidth of each sub-channel is 0.5 MHz, 1 MHz, 2 MHz or 4 MHz and all sub-channels are comprised in the frequency bands of 1.6 MHz to 100 MHz. Other bandwidth values and frequency band are however possible within the frame of the invention. According to the invention, the communication channel 200 used in training mode for the transmission of the periodic and coded training sequence can be any one of the sub-channels.

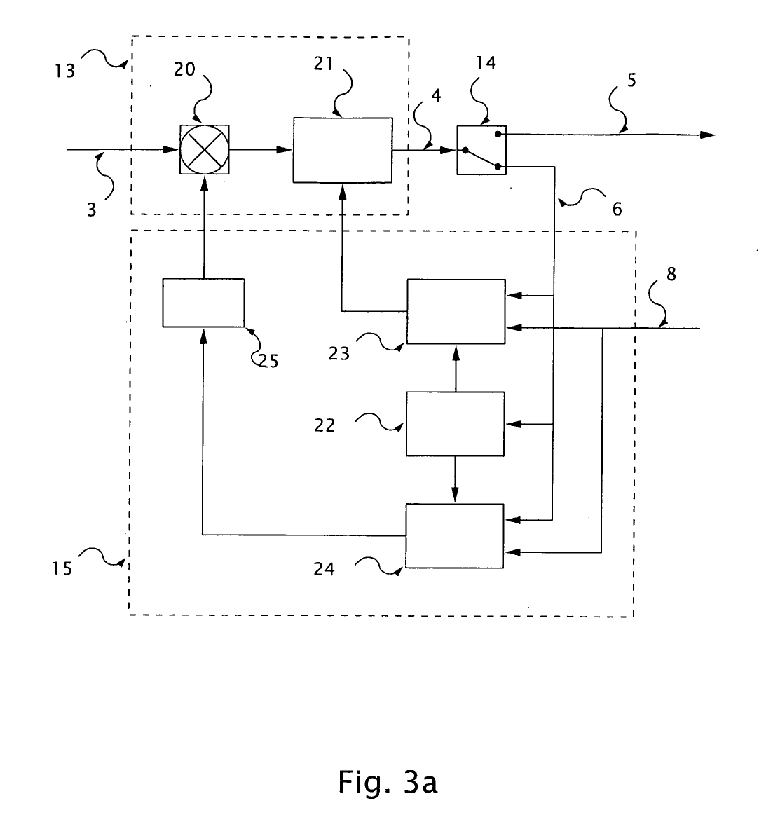

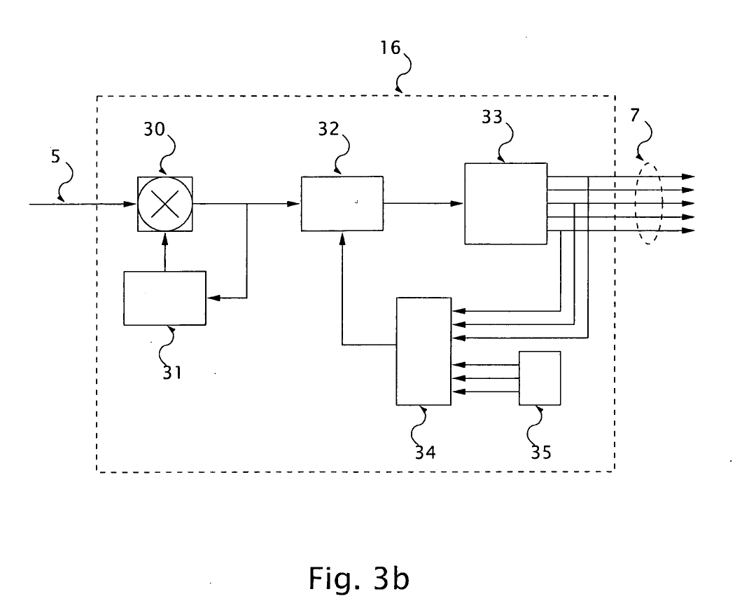

Details of the pre-processing unit 13 and of the coarse synchronization unit 15 according to a preferred embodiment of the invention are schematically represented in FIG. 3a. According to this embodiment, the pre-processing unit 13 comprises a frequency downshift multiplier 20 for the down-conversion of the received signal 3 in the bandpass case, and a time-domain equalizer 21 for minimizing the adverse effects of the communication channel 200. In training mode, the output 4 of the pre-processing unit 13 is directed by the switching means 14 to the input 6 of the coarse synchronization unit 15.

The coarse synchronization unit 15 comprises a time alignment module 22 for determining the time-alignment of the pre-processed received signal 4, a coefficient estimator 23 for estimating the coefficients needed for tuning the equalizer 21, and a carrier frequency offset estimator 24. Preferably, the coarse synchronization unit 15 further comprises a numerically controlled oscillator 25. In training mode, the coarse synchronization unit 15 receives an input signal 6 corresponding to the pre-processed received signal 4, and a locally generated periodic and coded training sequence 8. Time alignment is performed on the received signal 6, using known match filtering techniques adapted to the sent training sequence. The time alignment information is then given to both the coefficient estimator 23 and to the carrier frequency offset estimator 24 and to the filter bank 16.

The coefficient estimator 23 calculates the coefficients for the time-domain equalizer, on the basis of the CFO corrected received signal 6 which corresponds to the training sequence sent by the transmitter, and on the locally generated periodic and coded training sequence 8. The timing alignment information received from the time alignment module is used to calculate the error signal between the CFO corrected received signal 6 outputted by the equalizer 21 and the locally generated training sequence 8. The calculated coefficients are then forwarded to the equalizer 21 where they will be used for its tuning.

The equalizer 21 is for example a time-domain, infinite impulse response equalizer having poles and zeros. According to a variant embodiment, the equalizer consists of a fractionally-spaced finite impulse response unit and an infinite impulse response unit.

According to a preferred embodiment, the calculation of the coefficients of the equalizer 21 is done in the coefficient estimator 23 by minimizing a frequency weighted mean square error (MSE) between the known training sequence 8 and the equalizer output 4, thereby using the timing alignment information from time alignment module 22.

Preferably, the coefficients calculated in the coefficient estimator 23, for example the coefficients of the infinite impulse response part of the time-domain, infinite impulse response equalizer 21 having poles and zeros, are tested and adjusted, for example within the coefficient estimator, prior to be transmitted to the equalizer 21 in order to make sure that the new coefficients will result in a stable equalizer.

The carrier frequency offset estimator 24 also receives both the received signal 6 and the locally generated training sequence 8, together with the time alignment information determined by the time alignment module 22. The carrier frequency offset estimator 24 performs data-aided detection in order to estimate the frequency offset of the received signal 3. The thus determined carrier frequency correction is fed to the numerically controlled oscillator 25 in order to adjust the frequency downshift multiplier 20 accordingly.

Data Transmission Mode

Once coarse synchronization is achieved, the receiver is switched to data mode. With reference to FIG. 1, the signal 2 sent by the transmitter 100 then corresponds to the modulated data 1. The received signal 3 is frequency downshifted and equalized in the pre-processing unit 13, and the pre-processed received signal 4, 5 is directed to the signal processing unit 16 where it is demodulated.

The transmission of data 1 over the communication channel 200 is thus carried out using the filter bank modulator 10. Preferably, pilot signals are multiplexed into the data 1 to allow continuous synchronization between the receiver 300 and the transmitter 100 in data transmission mode. According to an embodiment, N pilot signals, (N being for example equal to 8), are used. According to a variant embodiment, the N pilot signals are sliding over the frequency band.

FIG. 3b illustrates the data processing unit 16 in more detail. The data processing unit 16 comprises of a carrier phase rotator 30 and a carrier phase estimator 31 for tracking the phase of the pre-processed received signal 5 and thus contributes to the continuous fine synchronization of the transceiver. The carrier phase estimator 31 senses the output signal of the carrier phase rotator 30, estimates the phase error either blindly or by use of the known pilot symbols, and sends this estimate and/or correction parameters to the carrier phase rotator 30 in order to adjust it to the actual phase of the received signal 5.

The data processing unit 16 further comprises an interpolator/re-sampler 32 and a multi-carrier demodulator 33, associated with a sampling offset estimator 34 and a pilot reference generator 35. The received signal 5, once processed by the carrier phase rotator 30, is re-sampled by the interpolator 32 and demodulated in the multi-carrier demodulator 33 which in turn outputs data 7 corresponding to the data modulated and sent by the transmitter 100. The sampling frequency offset is estimated in the sampling offset estimator 34 using known pilot signals locally generated in the pilot reference generator 35 and the outputs of the filter bank 33. The interpolator/re-sampler 32 then receives corrective measures from the sampling offset estimator 34 to correct the sampling frequency offset identified in the sampling offset estimator 34.

Thus, according to a preferred embodiment of the invention, fine synchronization of the transceiver during data transmission mode is achieved in that first the carrier phase jitter is corrected by the phase rotator 30, and second the information obtained from the pilot signals multiplexed in the data is used for fine symbol alignment and sample phase/sample frequency error correction by re-sampling the phase corrected received signal before forwarding it to the filter bank 33.

Switching Over from Training Mode to Data Transmission Mode

According to the invention and with reference to FIG. 1, once coarse synchronization is performed in the training mode, the receiver is switched over to data mode by means of the switching means 12 in the transmitter 100 and of the switching means 14 in the receiver 300. According to a preferred embodiment, this switch over is initiated by the training sequence table look-up 11 sending coded training sequence. The coded training sequence is detected in the receiver 300 and an order to switch the switching means 14 in the receiver 300 to data transmission mode is issued, while the switching means 12 in the transmitter 100 are also actuated in order to allow the transmission of the data 1 modulated using the filter bank 10 over the communication channel 200.

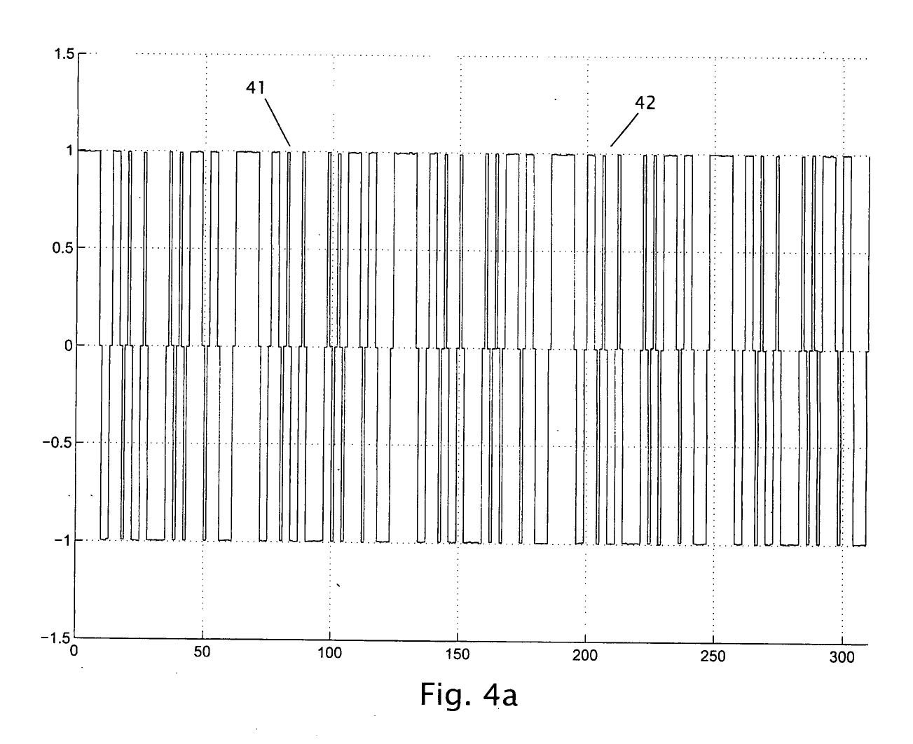

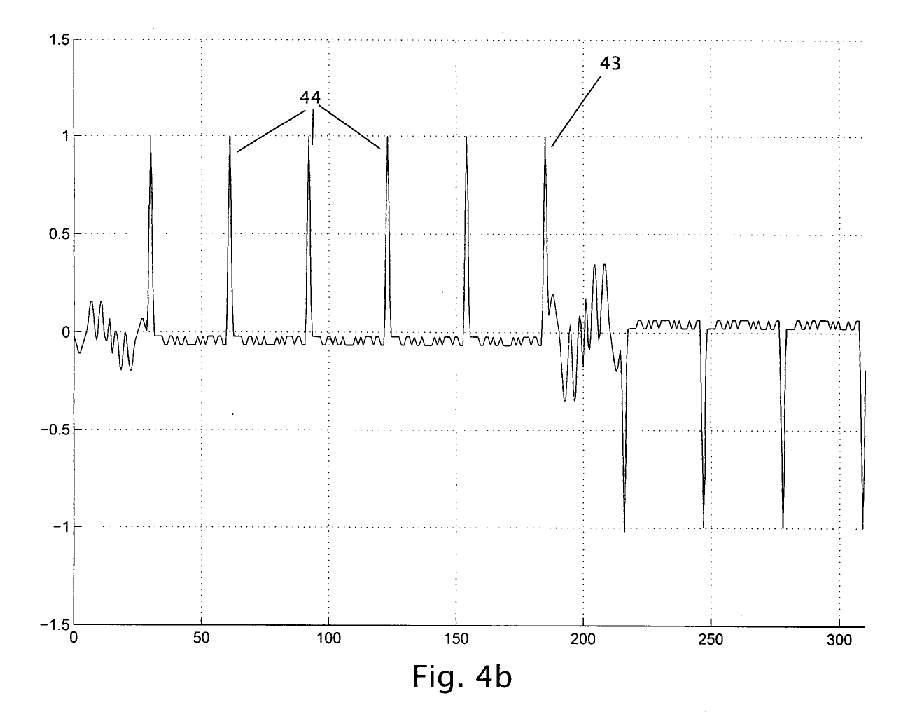

FIG. 4a shows an example of a periodic training sequence 41, together with an inverted training sequence 42, whereas FIG. 4b shows the corresponding matched filtering 43. In both figures, the sample index is reported on the horizontal axis, while the normalized amplitude of the signal is reported on the vertical one. The position of the peaks 44 of the matched filtered signal gives the time alignment information. The cross-correlation function is calculated in the coarse synchronization unit 15 using match filtering techniques.

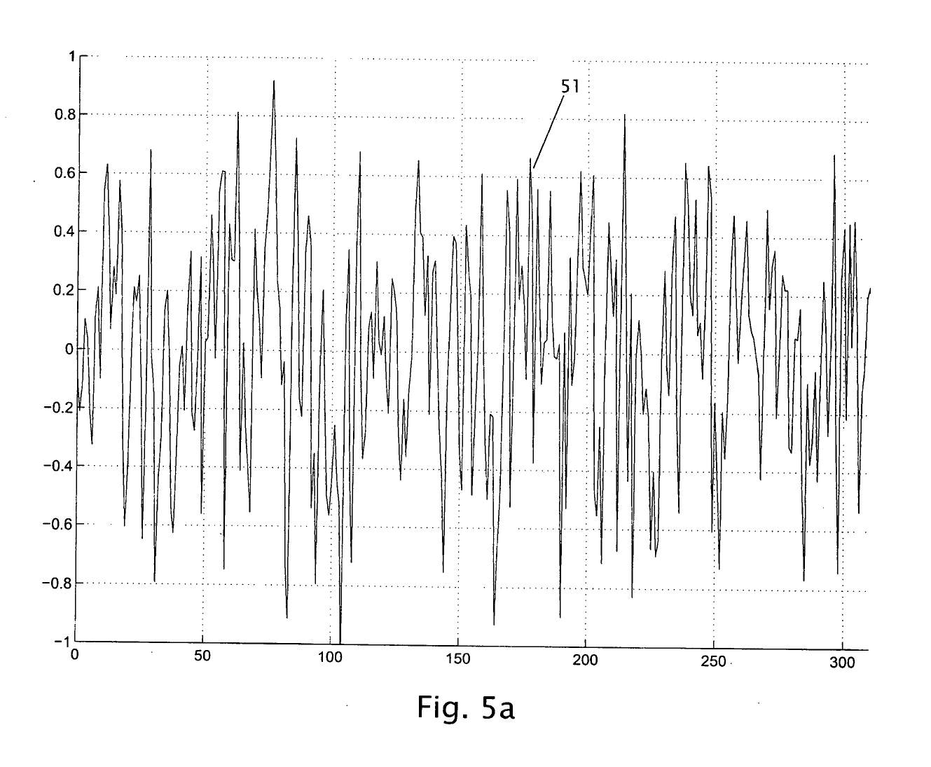

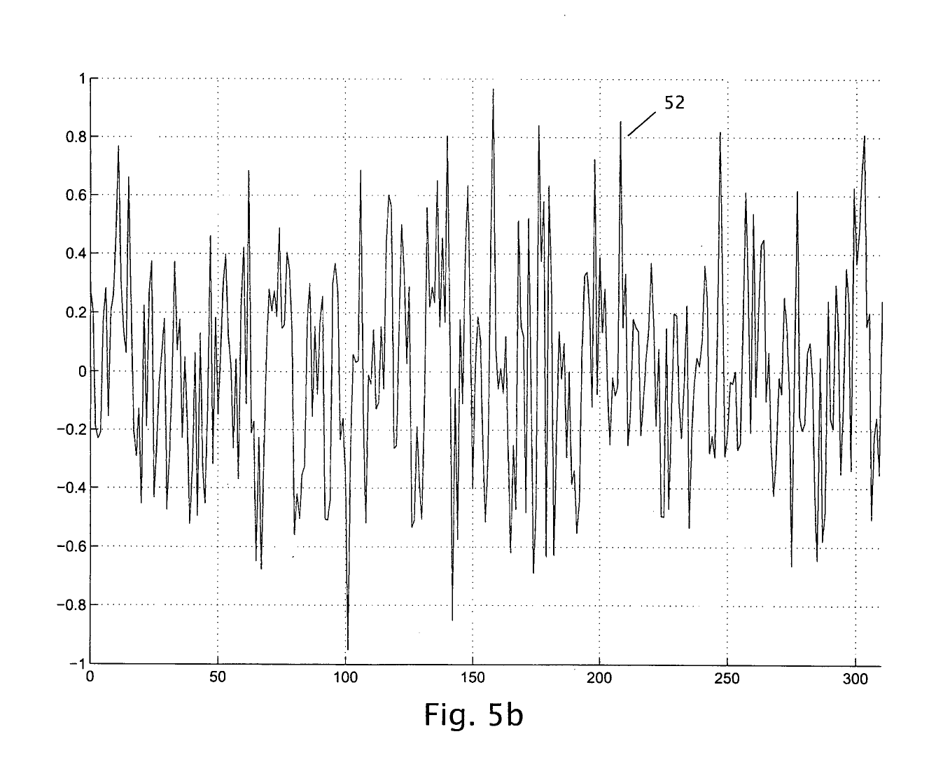

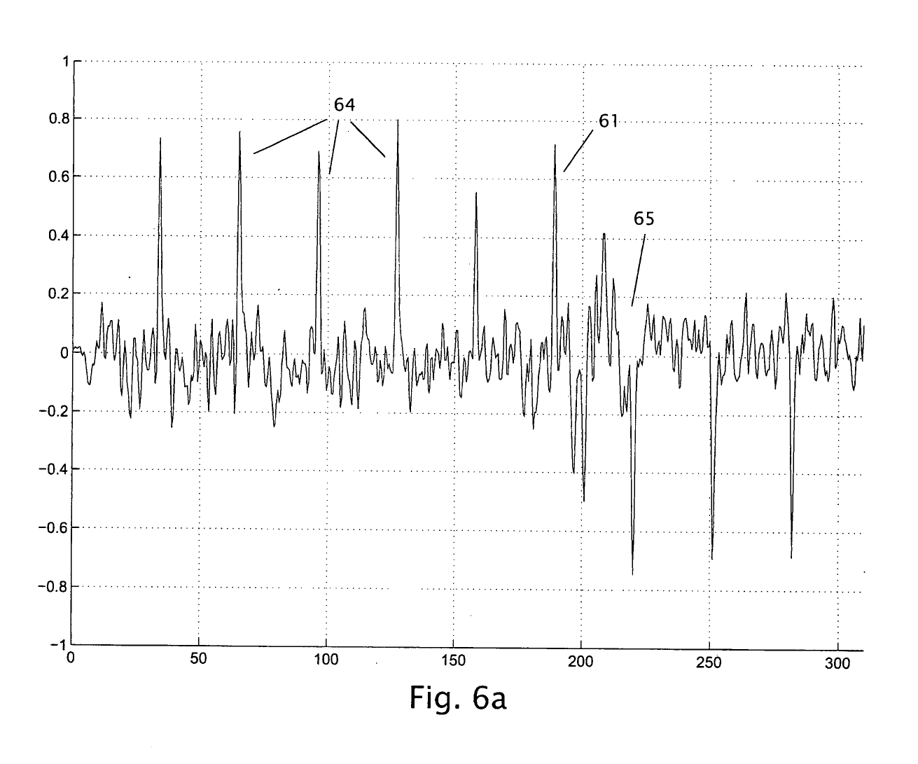

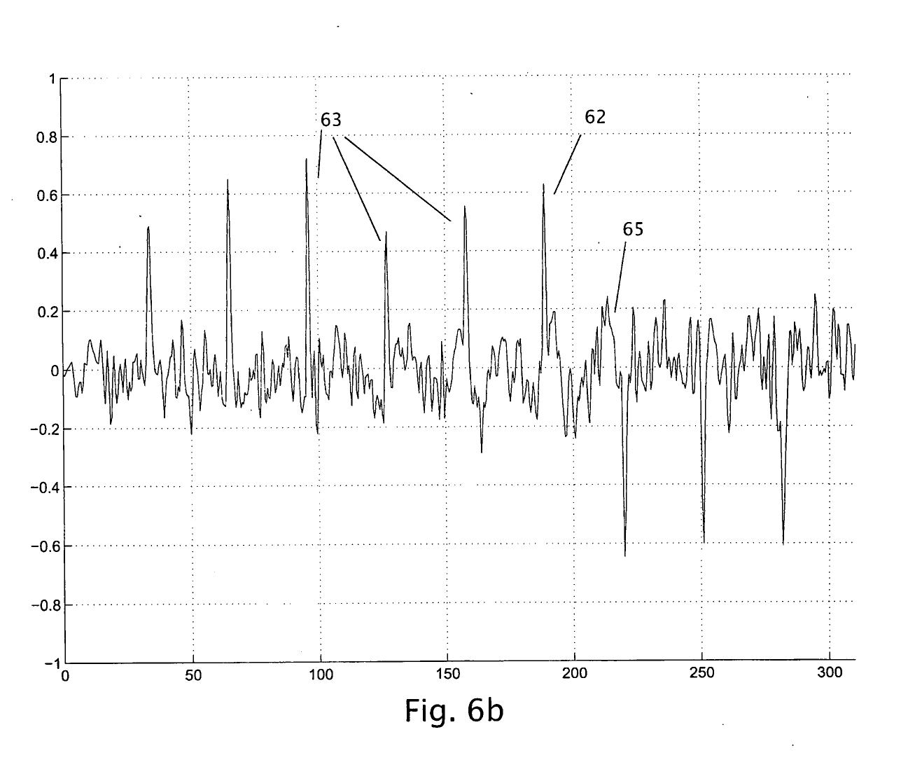

As a real world example, FIG. 5a shows the real part 51 of the received signal when the training sequence 41 and the inverted training sequence 42 of FIG. 4a are transmitted over either a baseband or bandpass noisy communication channel having a highly frequency-selective attenuation and phase response. In this example, the received signal has a signal-to-noise ratio of 0 dB. FIG. 5b shows the imaginary part 52 of the same received signal. The corresponding matched filter output 61, 62 are shown in FIG. 6a and FIG. 6b, respectively. In all these figures, the sample index is reported on the horizontal axis, while the normalized amplitude of the signal is reported on the vertical one. As explained above, the position of the peaks 63 or 64 of the matched filter output 61 or 62 is used for determining the time alignment information which is then used for the coarse synchronization of the transceiver. A sequence of matched filter output consisting of 61 and 62 is used to determine the instant 65 when the transceiver has to switch over to data transmission mode. Note that both matched filter output 61, 62 deliver the same time alignment information 63, 64 and indicate the same switch-over instant 65.

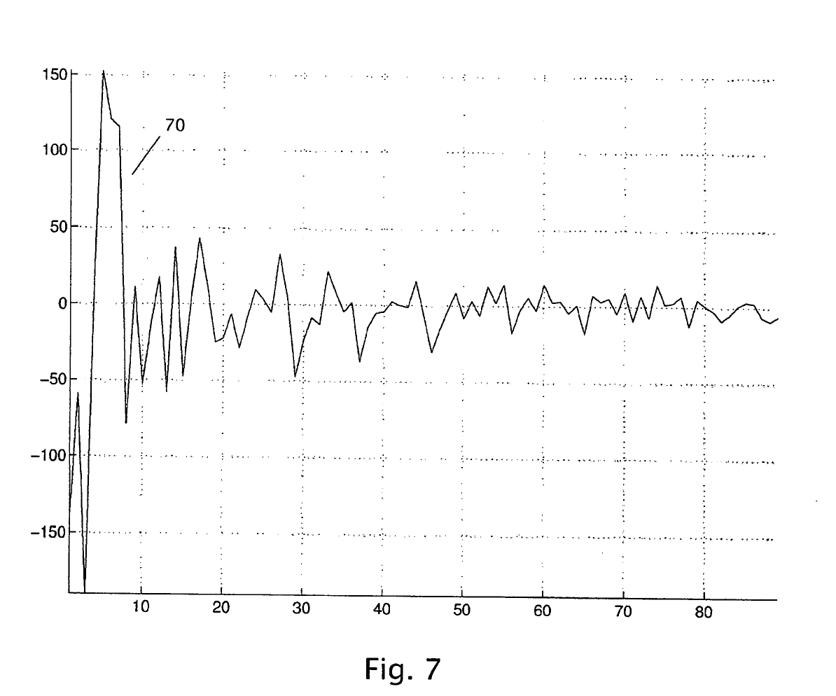

As shown in FIG. 7, the synchronization method of the invention allows achieving, during coarse synchronization, a reduction of the frequency offset 70 to within 10 Hz even at a signal-to-noise ratio of 0 dB and at a carrier frequency offset of 10800 Hz. In FIG. 7, the value of the frequency offset is reported in Hz on the vertical axis, while the iteration index of the coarse synchronization process is reported on the horizontal axis.

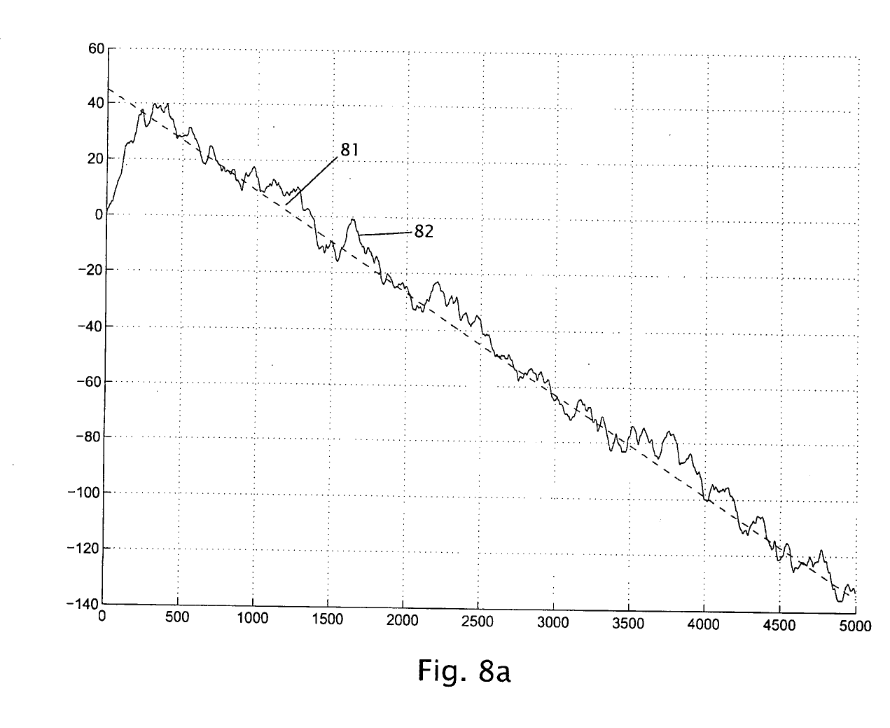

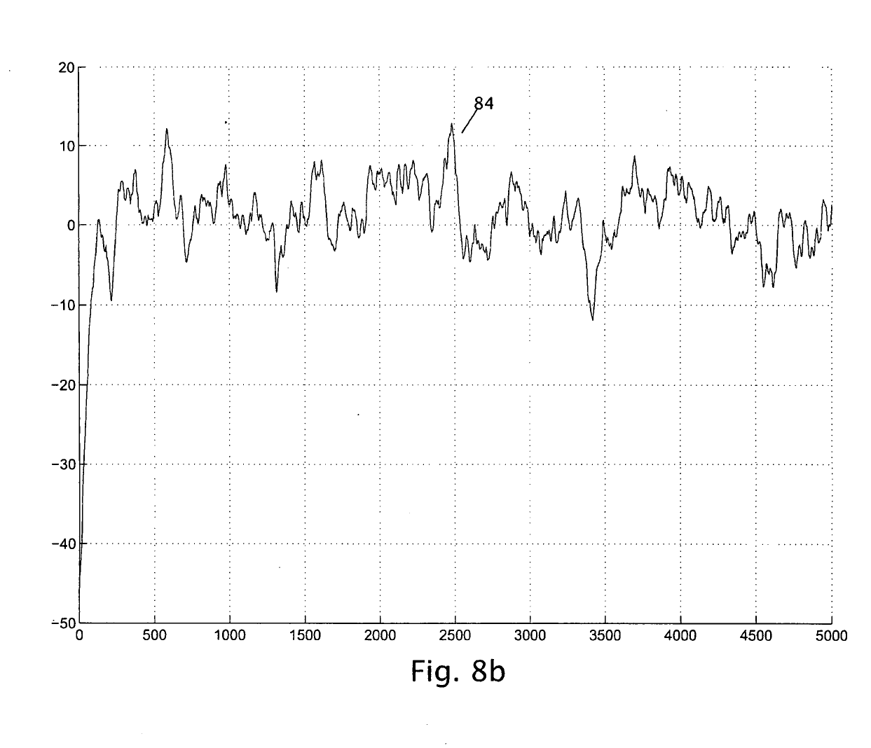

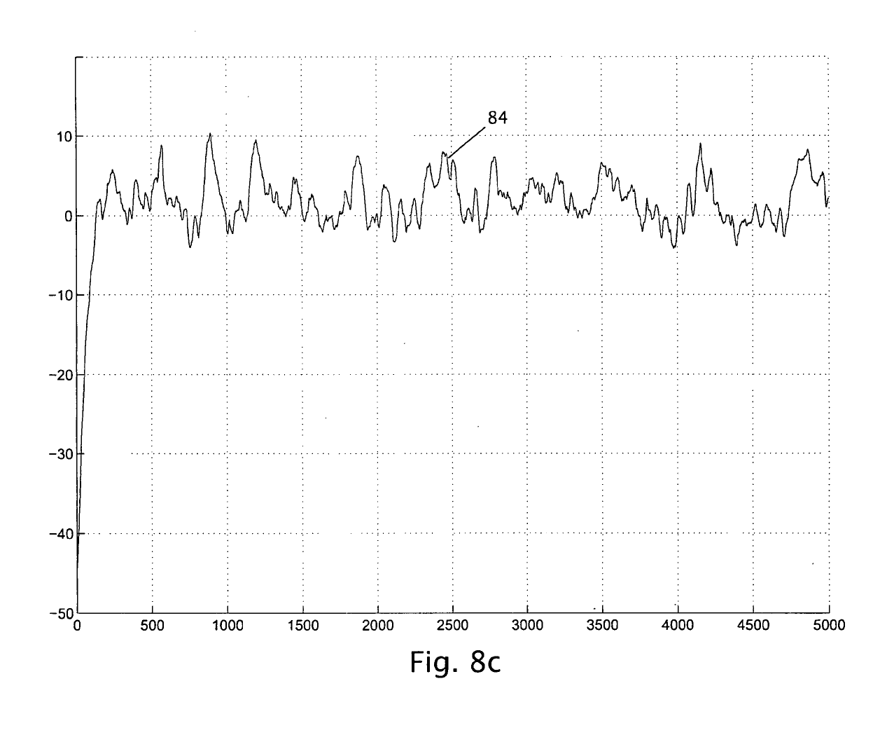

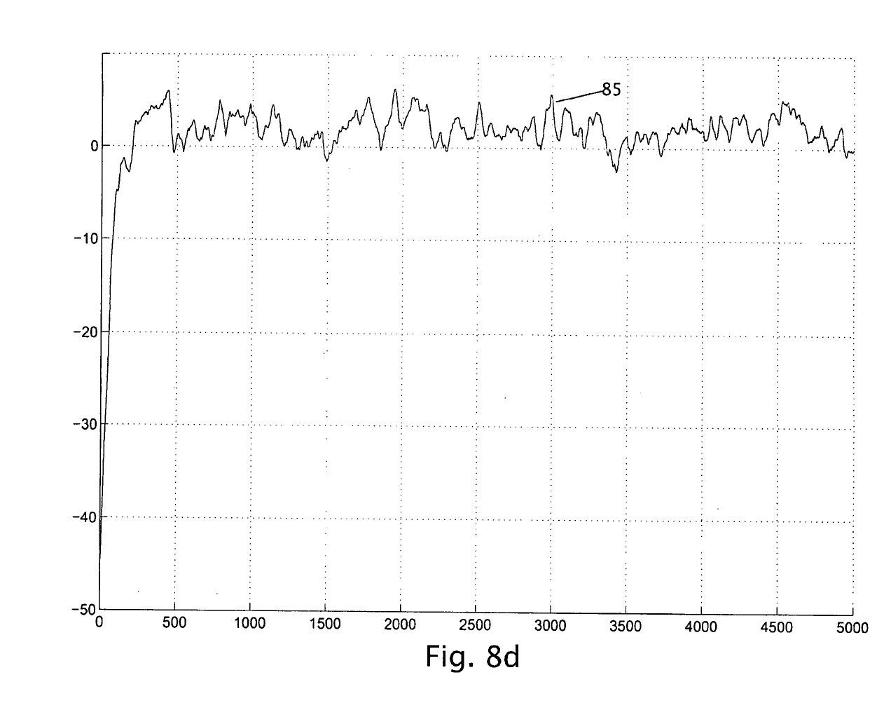

FIG. 8a illustrates as an example the tracking performance of the phase rotator in data transmission mode when the phase offset is 45°, the signal-to-noise ratio of the received signal is 0 dB, and carrier frequency offset is 100 ppm. In FIG. 8a, the sample index is reported on the horizontal axis, while the magnitude in degrees is indicated on the vertical axis. The dotted line 81 represents the phase offset, while the phase estimate is represented at 82.

The corresponding error signal 83 is shown in FIG. 8b. For comparison, the error signals 84, 85 resulting when the signal-to-noise ratio of the received signal is 5 dB and 10 dB are shown in FIG. 8c and FIG. 8d, respectively. The units reported on the vertical and horizontal axis are the same for all FIGS. 8a to 8d.

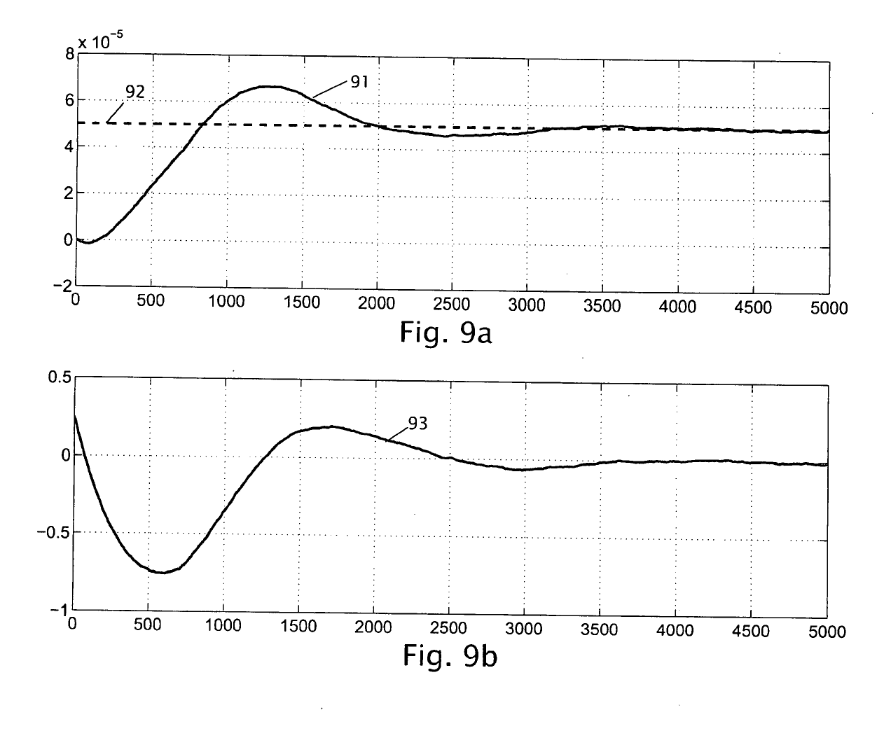

FIG. 9a shows an example of the sampling frequency offset estimation 91 at a sampling frequency offset of 50 ppm and at a signal-to-noise ratio of the received signal of 0 dB, using 8 pilots. The sampling frequency offset is reported in ppm on the vertical axis, while the multi-carrier symbol index is reported on the horizontal axis. The dotted line 92 represents the actual sampling frequency offset.

FIG. 9b shows the corresponding sampling phase offset 93. In FIG. 9b, the normalized sampling phase offset is reported on the vertical axis, while the multi-carrier symbol index is reported on the horizontal axis.

1. Synchronization method for a multi-carrier transceiver using a filter bank, said filter bank being either a cosine modulated filter bank or a wavelet packet filter bank or a complex modulated filter bank, said transceiver comprising a transmitter (100) and a receiver (300) able to communicate with each other over a communication channel (200), said method comprising the following steps:
in a training mode of operation: sending a periodic and coded training sequence over said communication channel (200) from said transmitter (100),
determining in said receiver (300) time alignment information from said periodic training sequence,
performing a coarse synchronization of said receiver (300) to said transmitter (100) using said time alignment information,
in a data mode of operation: sending multi-carrier modulated data (1) in mode over said communication channel (200) from said transmitter (100), pilot signals being multiplexed into said data (1),
tracking sampling frequency offset and phase jitter within said receiver (300) using said pilot signals,
performing the continuous synchronization of said transceiver with the help of the tracking information determined using the received pilot signals.

2. Synchronization method according to claim 1, wherein the transmitted training sequence does not occupy some forbidden frequency bands.

3. Synchronization method according to the previous claim, comprising a step of notching out the forbidden frequency bands from the training sequence.

4. Synchronization method according to any of the previous claims, wherein said step of performing a coarse synchronization includes calculating coefficients for the tuning of the time-domain channel equalizer (21) of said receiver (300).

5. Synchronization method according to the preceding claim, wherein said equalizer (21) is an infinite impulse response equalizer and wherein said coefficients are checked for stability prior to tuning said equalizer (21).

6. Synchronization method according to any of the preceding claims, wherein said step of performing a coarse synchronization includes estimating the carrier frequency offset of said training sequence in said receiver (300).

7. Synchronization method according to any of the preceding claims, wherein said step of performing the continuous synchronization of said transceiver includes simultaneously adjusting a phase rotator and an interpolator/re-sampler of said receiver (300).

8. Receiver (300) for the reception of multi-carrier signals, comprising:
a signal processing unit (16) using a filter bank for demodulating a multi-carrier signal, said filter bank being either a cosine modulated filter bank or a wavelet packet modulated filter bank or a complex modulated filter bank,
a pre-processing unit (13) for the pre-processing of a received signal (3),
a coarse synchronization unit (15) for determining tuning parameters of said pre-processing unit (13) in order to perform a coarse synchronization of said receiver (300) to a transmitter (100) when said transmitter (100) and said receiver (300) communicate with each other over a transmission channel (200),
switching means (14) for connecting the output of said pre-processing unit (13) either to said coarse synchronization unit (15) or to said signal processing unit (16),
characterized in that said coarse synchronization unit (15) comprises a time alignment module for determining time alignment information from a received training sequence (6).

9. Receiver (300) according to the preceding claim, said pre-processing unit (13) comprising a time-domain equalizer (21), said coarse synchronization unit (15) further comprising an equalizer coefficient estimator (23) for estimating the coefficients required for tuning said equalizer (21), using said time alignment information, said received training sequence (6) and a known training sequence (8).

10. Receiver (300) according to any of claim 8 or 9,
said pre-processing unit (13) comprising a frequency downshift multiplier (20),
said coarse synchronization unit (15) further comprising:
a carrier frequency offset estimator (24) for estimating the carrier frequency offset of said received training sequence (6) using said received training sequence (6), said time alignment information and a training sequence (8),
a numerically controlled oscillator (25) for adjusting said frequency downshift multiplier (20) on the basis of the carrier frequency offset estimated by said carrier frequency offset estimator (24).

11. Receiver (300) according to any of claims 8 to 10, said signal processing unit (16) comprising:
a carrier phase rotator (30),
a carrier phase estimator (31) for adjusting said carrier phase rotator (30) on the basis of the output of said carrier phase rotator (30).

12. Receiver (300) according to any of claims 8 to 11, said signal processing unit (16) comprising:
an interpolator/re-sampler (32) for re-sampling a received multi-carrier signal (5),
a filter bank demodulator (33) for demodulating a re-sampled multi-carrier signal (5), said filter bank being either a cosine modulated filter bank or a wavelet packet modulated filter bank or a complex modulated filter bank,
a sampling offset estimator for tuning said interpolator/re-sampler (32) on the basis of pilot signals multiplexed in said received multi-carrier signal (5).

13. Transceiver comprising a transmitter (100) and a receiver (300) according to any of claims 8 to 12, said transmitter (100) and said receiver (300) being able to communicate with each other over a communication channel (200).

14. Transceiver according to the preceding claim, said transmitter (100) comprising:
a filter bank modulator (10) for modulating input data (1) into a multi-carrier signal, said filter bank being either a cosine modulated filter bank or a wavelet packet modulated filter bank or a complex modulated filter bank,
a training sequence generator (11) for generating the training sequence, in which the forbidden frequency bands are notched out.
switching means (12) for connecting the input of the modulator (10) either with the input data (1), or with the output of said table look-up (11).
